(19) United States
(12) Patent Application Publication
(10) Pub. No.: US 2025/0018557 A1
(43) Pub. Date: Jan. 16, 2025

(54) INSERTION TOOL

(71) Applicant: Rolls-Royce plc, London (GB)

(72) Inventors: Liam D. HARRISON, Derby (GB); Ian Kennedy, Derby (GB)

(73) Assignee: Rolls-Royce plc, London (GB)

(21) Appl. No.: 18/752,042

(22) Filed: Jun. 24, 2024

(30) Foreign Application Priority Data
Jul. 12, 2023 (GB) 2310683.4

(51) Int. Cl. B25J 9/10; B25J 9/00

(52) U.S. Cl. CPC B25J 9/102; B25J 9/0015

(57) ABSTRACT

A feed mechanism for inserting and/or retracting a flexible robotic arm from an area, the feed mechanism including a housing, a passageway extending about a central longitudinal axis through the length thereof, a drive portion and rotational portion, the drive portion not being fixedly connected within the housing and having at least a pair of drive wheels coupled to a drive motor, the drive wheels are connected to a mounting frame with the mounting frame being connected to pivotable linkages with at least one of the linkages being connected to a spring, such that the expansion or contraction of the spring allows the drive wheels to move relative to the longitudinal axis, and the rotational portion being coupled to a motor, the rotational motor having a gear system that connects to the drive portion and causes a rotation of the drive portion about the central longitudinal axis within the housing.

### CROSS-REFERENCE TO RELATED APPLICATIONS

This specification is based upon and claims the benefit of priority from United Kingdom patent application GB 2310683.4 filed on Jul. 12 2023, the entire contents of which are incorporated herein by reference.

### BACKGROUND

### Technical Field

The disclosure relates to a feed mechanism for inserting a flexible robotic arm into a body or a workspace. In particular, the disclosure relates to a feed mechanism in which the diameter of the flexible robotic arm can be changed.

### Description of the Related Art

Repair and inspection of complex objects such as gas turbine engines, nuclear power plants, underground caballing, pipes and equipment for oil and gas processing is of growing importance as these industries grow. In all of these examples there are issues with the ease of access to perform the repair and inspection steps; this is either because of confined access, dangerous environments, complexities or cost in removing the equipment. To overcome these limitations there has been growing interest in robotic tools and probes that are able to work within these confined and difficult environments. Examples of such systems are borescopes and continuum or compliant robots. Furthermore, outside of engineering purposes, there is a growing interest in flexible robotics for use in medical and health application, such as endoscopes and key-hole surgery.

However, despite the growing maturity of these hyper-redundant probes and robots there are still issues with their operation. One such issue is that these robots and probes are long snake like objects that can be heavy, and their weight can be unevenly distributed, with the heavier section of the probe or robot at the distal end where the tools or more compliant sections are housed. This makes the feeding of the robot into the access port or the entrance to the work area difficult. The feeding process is typically carried out by hand with an operator manually feeding the probe or robot into the workspace or body. Such an action places strain on the operator especially in cases where the access is in a difficult or awkward to reach area. In such cases the operator will have to support the weight of a large portion of the probe or robot whilst having to manually feed the length of it into the work area. This means that a skilled operator is required to do this as they have to be able to understand the process and forces involved; this reduces any form of automation of the process as each inspection will be unique as there is no computer control of the system. However, the weight of the robot and the positioning can place strain on the body which can result in injury. Consequently, it is desirable to improve the setup for feeding such robots into the workspace or body.

### SUMMARY

According to a first aspect of the disclosure there is provided a feed mechanism for inserting and/or retracting a flexible robotic arm from an area, the feed mechanism comprising a housing, a passageway that extends about a central longitudinal axis through the length of the housing, a drive portion and a rotational portion, the drive portion not being fixedly connected within the housing and having at least a pair of drive wheels coupled to a drive motor, the drive wheels are connected to a mounting frame with the mounting frame being connected to pivotable linkages with at least one of the linkages being connected to a spring, such that the expansion or contraction of the spring allows the drive wheels to move relative to the longitudinal axis, and the rotational portion being coupled to a motor, the rotational motor having a gear system that connects to the drive portion and causes a rotation of the drive portion about the central longitudinal axis within the housing.

An interchangeable core section may be provided, the core section comprising a feed section and cut aways sections, the feed section being the portion through which the robotic arm is inserted, and the cut away sections allowing the drive wheels to pass into the core section and to connect with the flexible robotic arm when present, the core section having a diameter suitable for the robotic arm.

The spring may be coupled to a threaded screw coupled to a knob, so that rotation of the screw by turning the knob causes a variation in the length of the spring.

The feed portion may be mounted within the housing on roller bearings that extend around the feed portion.

The drive motor may be connected to a sub-frame within the housing, the drive motor providing rotational movement to a first drive shaft which is connected to a spur gear system, the spur gear system is connected to a second drive shaft having a worm wheel and a pair of roller bearings mounted on either side of the worm wheel, the worm wheel being coupled to a pair of worm gears that are mounted about their rotational axes and connected to drive wheel drive shafts, with each drive shaft having a pair of roller bearings mounted either side of a drive wheel

The rotational portion may comprise an electric motor coupled to a frame, the electric motor being connected to a spur pinion that is coupled to a spur gear, the spur gear being attached to an axle with a pair of bearing races connected either side of a worm gear, the worm gear being coupled to a worm wheel which is mounted about the outer face of the feed portion

Any of the gear systems may be coupled to an encoder so that the positional movement of the flexible robotic arm can be determined.

The drive wheels may be coated with polyurethane, or natural or artificial rubber.

The feed mechanism may be provided with a light gate to determine the position of the flexible robotic arm within the feed mechanism.

The feed mechanism may be provided with a mount on the housing.

The feed mechanism may be provided with a flange that can be coupled to a mounting bracket.

The feed mechanism may be connected to a feed pipe, wherein the passageway extends continuously throughout the feed mechanism and into the feed pipe.

There may be two pairs of drive wheels, with the pairs of drive wheels being positioned at opposite sides of the housing. Only one of the drive wheels may connected to the drive motor.

Both sets of drive wheels may be connected to the springs.

The skilled person will appreciate that except where mutually exclusive, a feature described in relation to any one of the above aspects may be applied mutatis mutandis to any other aspect. Furthermore, except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 presents a rear perspective view of the feed portion 10 without the housing according to the prior art;

FIG. 2 presents a cross sectional view along the longitudinal axis of the feed mechanism;

FIG. 3 presents an example of the drive portion of the feed mechanism;

FIG. 4 presents an example of the twist portion of the feed mechanism;

FIG. 5a presents an example an external perspective of an end of the housing;

FIG. 5b presents a cut away of the set up in FIG. 5a; and

FIG. 6 presents an exemplary method of using a feed mechanism.

### DETAILED DESCRIPTION

Aspects and embodiments of the present disclosure will now be discussed with reference to the accompanying figures. Further aspects and embodiments will be apparent to those skilled in the art.

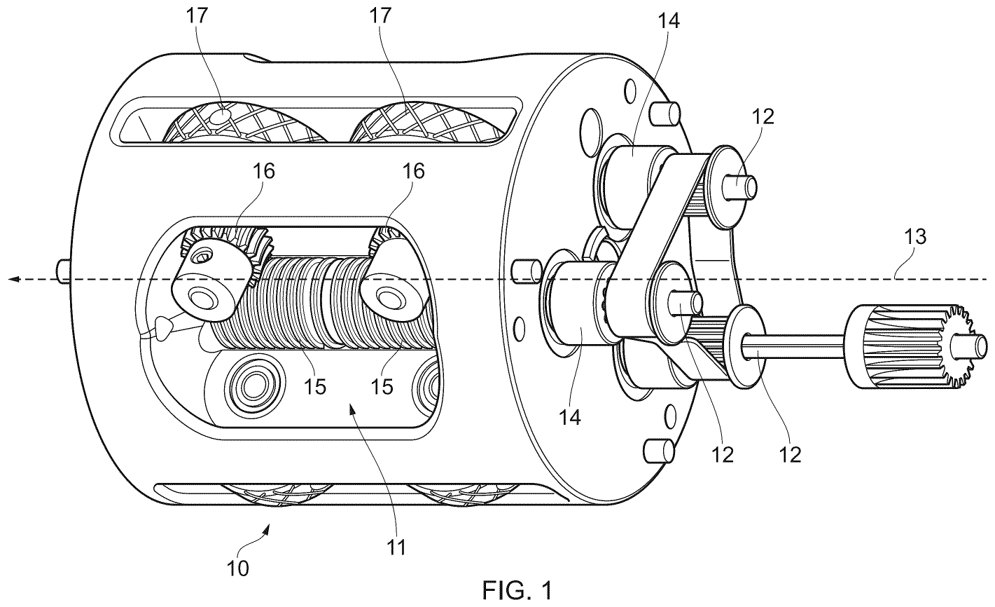

FIG. 1 presents a rear perspective view of the feed portion 10 without the housing according to the prior art. The feed portion comprises a feed actuator 11, which is configured in use, to engage with and to drive the flexible robotic arm along the longitudinal axis of the mechanism. The feed mechanism, therefore, is configured to drive the flexible robotic arm through the mechanism and into the desired workspace or body. The term flexible robotic arm is used to cover robotic arms such as borescopes, endoscopes, continuum arm, snake robots hyper redundant robots, and any other similar suitable device. A flexible robotic arm may also feature rigid section in addition to the flexible portion. A flexible robotic arm may also feature passive sections that are not controllable. The feed portion comprises one or more feed portions. The feed portions are configured about the passageway that runs through the mechanism and is configured to engage with and drive the flexible robotic arm along the passageway. In the example shown the feed actuator comprises three axial feed shafts 12. Each feed shaft is configured about the passageway such that the shafts 12 extends along axes which are parallel to, but radially offset from the longitudinal axis 13. This radial offset is fixed so that the device is configured so that only a fixed size flexible robotic arm can be driven through the mechanism. The feed actuator comprises three axial shafts. Each feed shaft is configured within roller bearings 14 at either side of the respective shaft and comprises worm gears 15. Each worm gear moves a respective worm wheel 16, wherein the worm wheels are mounted on a worm wheel shaft. The worm wheels are mounted to the worm wheel shaft via a wheel and are supported by two roller bearings. Each of the worm wheels drives a wheel 17. A tangent of each wheel at the point of engagement with the flexible robotic arm extends parallel to but radially offset to the longitudinal axis. The offset is fixed to the radius of the flexible robotic arm. In use the wheels grip the flexible robotic arm and rotate in order to drive the flexible robotic arm along the longitudinal axis. One of the difficulties with the use of such a system is that it can only be used on a fixed diameter robot. Therefore, if a different diameter robot or probe is required, to perform the desired task, the system requires a separate mechanism to feed the flexible robotic arm into the area of interest.

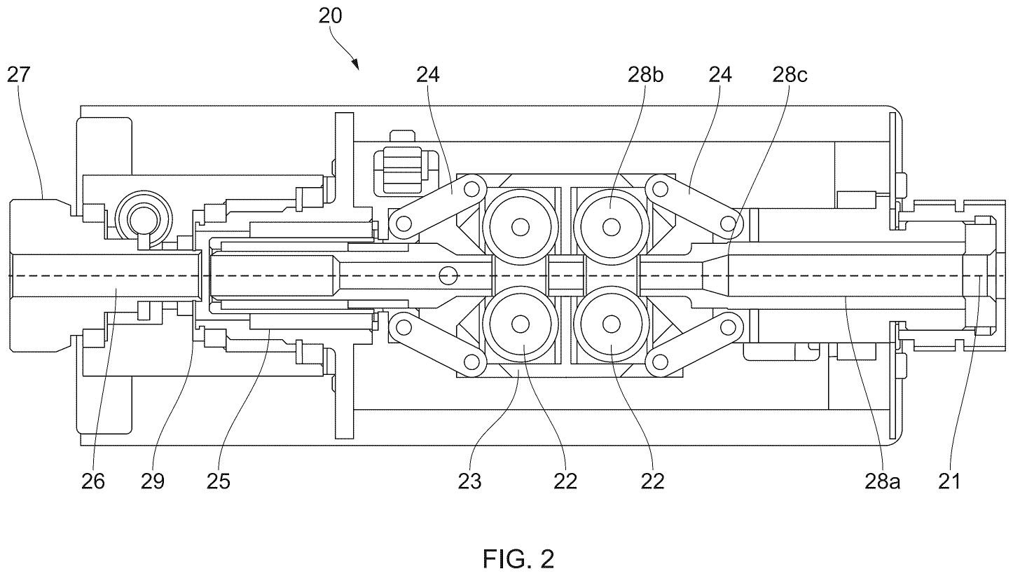

FIG. 2 presents a cross sectional view along the longitudinal axis of the feed mechanism according to the present disclosure. The feed mechanism 20 comprises a flexible robotic arm that extends along a longitudinal axis 21. A passageway is formed to allow the flexible robotic arm to pass through, with its centre being along the longitudinal axis. The flexible robotic arm is driven through the mechanism by a plurality of drive wheels 22 that are used to engage with pressure against the flexible robotic arm, so as to add friction to the cable so that it can be moved along the longitudinal axis 21. The drive wheels are driven via a worm gear having a spur reduction. Each of the drive wheels may be driven. Alternatively, only one set of drive wheels can be used, and the other drive wheels being used for guiding and rotating by through friction with the robotic arm. The drive wheels may be coated with polyurethane, or natural or artificial rubber to provide extra grip. The drive wheels may be mounted in pairs. The drive wheels are mounted to a frame or carriage 23 that is connected pivotally via a pair of linkage bars 24. The frame or carriage is mounted on linear bearings. The frame or carriage houses a compression spring that reacts between the carriage and the robotic arm in the core. The compression springs interaction with the frame creates tension in the linkage mechanism and therefore acts to preload forces between the drive wheels and the robotic arm. The frame extends longitudinally along part of the length of the mechanism. The spring extends along the axis of the central passageway and has a set tension. The tension is set so that the wheels on the carriage are configured to contact the outside of the flexible robotic arm when it is set to the smallest diameter of flexible robotic arm to be used. Due to the spring tension the wheels are forced down against the flexible robotic arm; this along with the coating helps to maintain frictional contact with the flexible robotic arm. In order to use different size robot arms the feed core 28a, 28b, and 28c of the feed mechanism can be changed. The screw is then used to keep the core in place and to compress the spring. Alternatively, a screw may be employed to provide a means of adjusting the tension of the spring. The screw can be used to adjust the length of the spring relative to a fixed end. The screw can be controlled by rotation of knob 27. Alternatively, the tension on the springs may be preloaded. The advantage of this configurations is that the pivotable linkages are able to change their angle so that the radial spacing between the wheels and the longitudinal axis is increased. This allows the feed mechanism to take larger diameter flexible robotic arms. There may be a single pair of mounted wheels, so that only one side of the feed mechanism expands in the radial direction. However, to allow for a centred feed about the mechanism, two or more pairs of wheels may be mounted in pairs and connected to the springs. Such a configuration also increases the friction that acts between the drive wheels and the flexible robotic arm. The drive wheels may be mounted to a carriage. The mounting can be coupled to the linkage pins, so that the wheels move together. The mounting may extend around the wheels and connect to bearings with the wheel axis running through them. There may be four pairs of drive wheels each mounted perpendicular about the longitudinal axis, or alternatively there may be 3 drive wheels orientated at 120° about the longitudinal axis. However, the example shown in FIG. 2 has only two pairs of wheels. Such a configuration allows for the electrical connections to be added into the housing and to maintain it as a convenient size and shape.

About the longitudinal axis there is a feed core or passageway 26. The feed core comprises a central tube 28a that allows for easy feed of the flexible robotic arm. There is a plurality of cut away sections 28b of the feed core that allow axis for the drive wheels, as discussed above, to extend into the feed core. The cut away sections are so sized to allow the drive wheels to move deeper towards the longitudinal axis within the core; this allows the wheels to move relative to the size of the flexible robotic arm that is being used. The feed core is shown having a taper section 28c; this makes the feeding of the flexible robotic arm easier as it can be fed into the rear of the feed core. The feed core may be interchangeable. The drive mechanism may be coupled to an encoder, so that it is possible to detect a slip on any of the drive wheels that are powered to move the flexible robotic arm. Any slip, if undetected, could potentially result in an incorrect determination of the amount of flexible robotic arm that has been inserted into the workspace, which could potentially result in damage of the tool, probe or the flexible robotic arm itself. A light gate may also be used to detect a presence of the flexible robotic arm within the mechanism. The light gate may be positioned after the drive wheels and can determine the position when the robot is first inserted into the device and fed beyond the light gate.

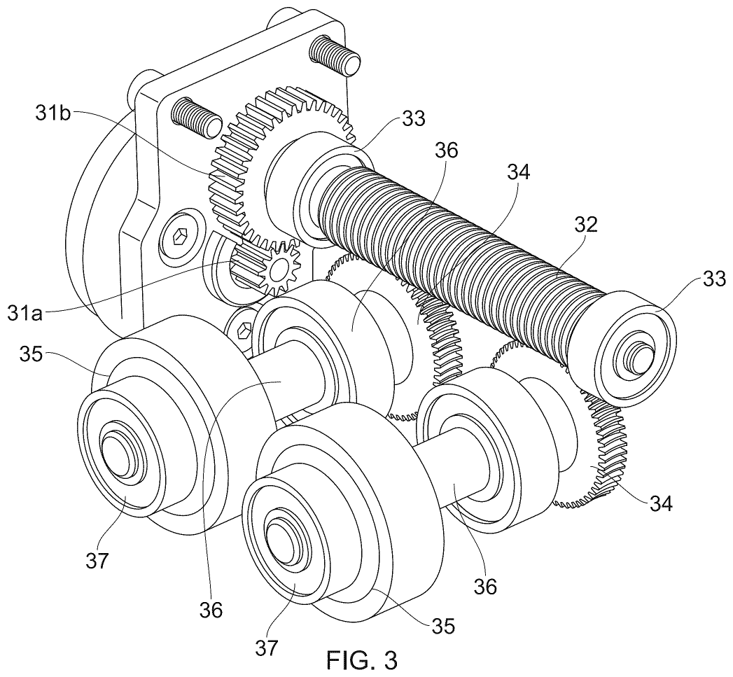

FIG. 3 also presents the twist portion 29 of the feed mechanism which is positioned at the end of the mechanism. The twist portion of the feed mechanism comprises a worm gear that is provided around the passageway 26. The worm gear is connected to a worm wheel. The passageway is connected to the feed mechanism, which is rotatably mounted within the housing, so that rotation by the twist portion of the feed mechanism results in rotation of the feed mechanism. This in turn rotates the flexible robotic arm, which is gripped by the drive wheels of the feed portion of the feed mechanism.

In use the flexible robotic arm is fed into the feed core of the mechanism and inserted until it connects with the drive wheels. This can be through the use of an interchangeable feed core that is sized to use with the size of the robotic arm. The different feed cores can be provided to cover a small range of diameters: for example, for a 6 mm robot a core may cover 5.5-6.5 mm, or for a 12 mm robot the core may accommodate 11-13 mm. For example, suitable core sizes may be 6 mm, 8 mm, 10 mm and 12 mm. Other suitable size diameters can be used with the disclosure. Alternatively, the tension of the drive spring is reduced prior to insertion to allow for easy motion of the flexible robotic arm passed the drive wheels. Depending upon the accuracy and the size range of the different flexible robotic arms being used the tension of the spring may not need to be changed manually. In cases where there is only a small difference the tension can be set for the smallest diameter of the flexible robotic arm and when a larger diameter flexible robotic arm is inserted the member acts against the wheels and increases the tension on the springs. The movement of the tensioning springs may be achieved automatically using a drive motor with a torque limiter rather than through the use of a knob. Once the system is in this position the mechanism is ready and it can be coupled to the area for deployment if it has not already been positioned there already and the system can be deployed. In this position the flexible robotic arm of any size can be fed into the work area and the twisted to the desired position within the work area.

FIG. 3 presents an example of the drive portion of the feed mechanism. The drive portion 30 comprises an electrical motor that is connected to a sub-frame within the housing mechanism. The electrical motor provides rotational movement of a drive shaft when a voltage is applied by the operator to drive the feed mechanism. The electrical motor is connected to a spur gear system, which is shown comprising of two gears. In this case the first gear 31a is connected to the drive shaft of the electrical mechanism, whilst a second gear 31b is driven by the first gear. The second gear is connected to a drive shaft which has a worm wheel 32 mounted at the centre of the drive shaft with a pair of roller bearings 33 mounted on either side of the worm wheel. The worm wheel is coupled to a pair of worm gears 34. The worm gears are mounted about rotational axes and connected to the drive wheel drive shafts that rotate about this rotational axis. The drive shafts 36 have a pair of roller bearings 37 mounted upon them. The drive shafts have the drive wheels 35 connected to them. The drive wheels are also shown having an outer layer that is used to connect it to the flexible robotic arm.

In use, when a voltage is applied to the electrical motor, it is able to rotate clockwise or anticlockwise. The drive from the motor is passed to the spur gears which rotate the worm wheel. The rotation of the worm wheel is passed onto the worm gears and results in their rotation. As the worm gears are connected to the drive shaft this causes rotation of the worm gear. The rotation of the drive shaft causes rotation of the drive wheels, which causes a linear movement of the flexible robotic arm about the longitudinal axis. As the motor can rotate both clockwise and anticlockwise it means that the drive wheels can move the flexible robotic arm both forwards and backwards allowing the flexible robotic arm to be moved in and out of the workspace.

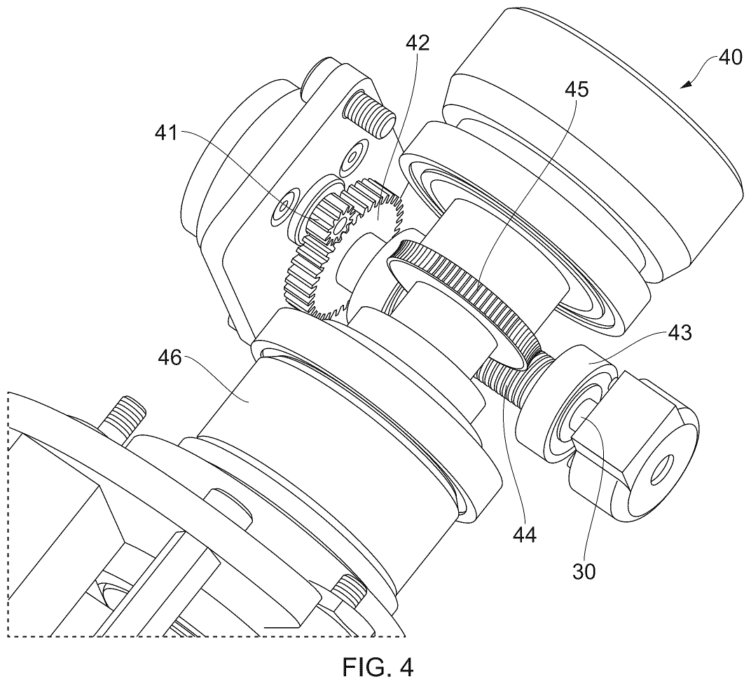

FIG. 4 presents an example of the twist portion of the feed mechanism. The twist portion comprises an electric motor coupled to a frame. The electric motor is connected to a spur pinion 41. The spur pinion is coupled to a spur gear 42 which is attached to an axle or worm shaft. The axle is coupled to a pair of bearing races 43 which has a worm gear 44 mounted between the bearing races. The worm gear couples with a worm wheel 45 which is mounted about the outer face of the feed portion of the feed mechanism 46. In use the twist portion is able to rotate the feed portion about the longitudinal axis within the housing. An encoder may be coupled to the worm shaft or axle so that the state of twist of the flexible robotic arm can be determined. Hard stops may be used to prevent over rotation of the flexible robotic arm, which may damage the robot in use. The presence of the spur gear system means that a controlled speed of rotation can be achieved from the motor; thus, increasing the usability and dexterity of the flexible robotic arm.

In use a voltage is applied to the twist drive motor; this is determined from a signal that determines the required amount of rotation. The signal may be based upon a history of the signals applied and/or any signals provided by an encoder as to the position, and/or by information from the tool or probe on the end of the flexible robotic arm. In order to accurately know the position, the flexible robotic arm may be fed into the feed mechanism is a set way so that the total position of the flexible robotic arm is known. The twist motor is able to rotate the pinion gear and thus turn the spur gear. The spur gear being connected to the worm shaft and gear means that worm gear rotates. This rotation of the worm gear in turn drives the worm wheel and thus the rotation portion of the feed mechanism within the housing. With the flexible robotic arm in the feed portion of the feed mechanism the body of the robot can be rotated into a suitable position so as to bring the tool or probe on the end of the flexible robotic arm into position relative to the component or workpiece.

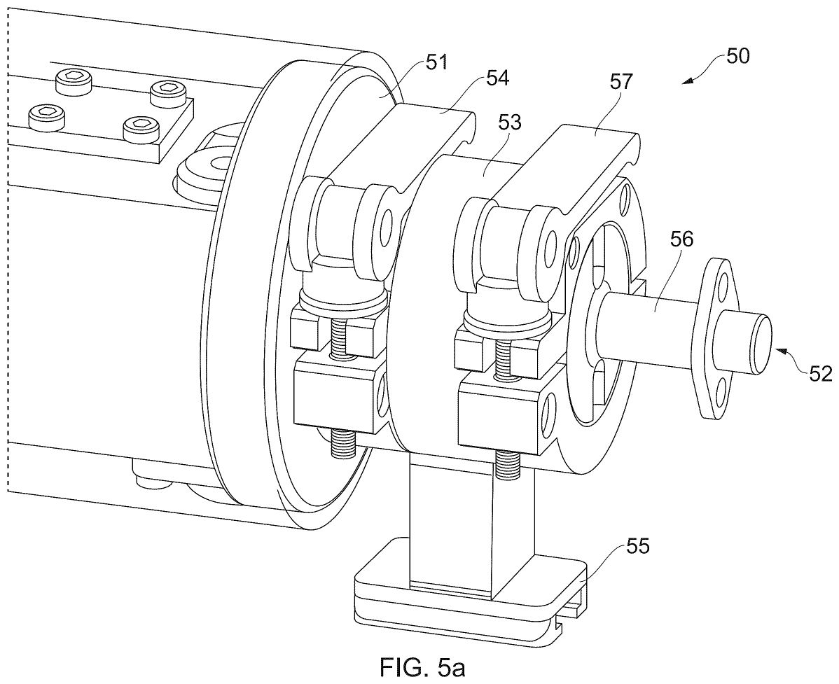

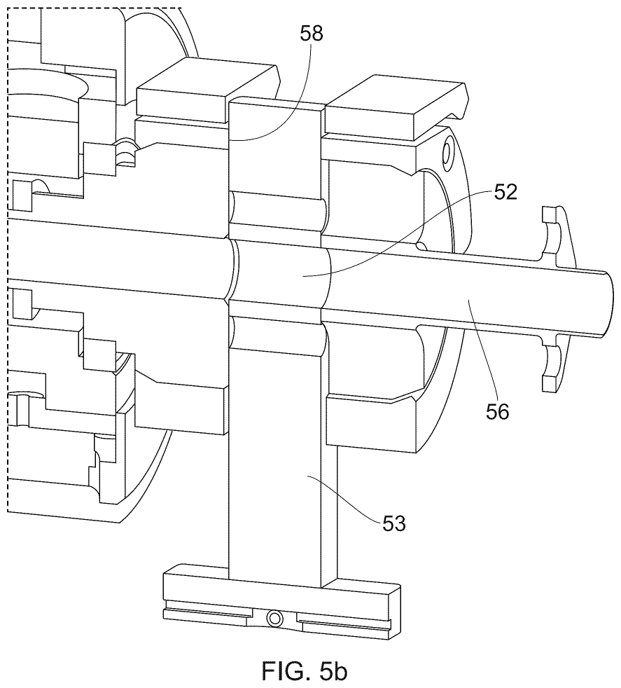

All of the components may be enclosed within a housing. The housing may be made of any suitable material, for example this may be a metallic, composite or plastics material. The end of the housing may be provided with a flange, to allow it to couple with the housing or a support. FIG. 5a presents an example an external perspective of an end of the housing 50 according to the present disclosure. The distal end of the housing 51 has an end wall that covers the mechanical and the electrical components within the mechanism. The end wall has a flange extending therefrom. Through the centre of the flange is passageway, which forms an extension of the passageway that passes through the mechanism. The continuation of the passageway 52 allows the flexible robotic arm to pass through the feed mechanism smoothly. The flange is provided with a coupling face to allow it to couple with another component if required. In the example shown in FIG. 5a the flange is paired with a mount 53. The mount and the flange are held together by a ring clamp 54. However, if needed they could also be held to together by bolting the components together, or other suitable mechanisms. The mount shown has a mounting passageway that aligns with the passageway that extends through the mechanism. The mount also features a projection that has a support plate 55. The support plate may be shaped to couple with a tripod, or other similar support structure so that the mechanism is held in the required position relative to the inspection port. Alternatively, the projection may be a permanent physical mount to a support structure that is configured to hold the feed mechanism at a set position. For example, if the feed mechanism is used in medicine, it may be a mount directly to an operating table, alternatively, if the feed mechanism is used for telecommunications cables, then the support may be a stand that positions it about the access hole for the cables. In use the mount is there to take the weight and the associated forces away from any couplings that may become damaged. In FIG. 5a the mount is further coupled to a feed tube 56. In this the mount also has a mounting face and flange that allows it to abut and couple with the feed tube. In FIG. 5a the mount and the feed tube are clamped together by a ring clamp 57. However, any other suitable clamping mechanism can be used. The feed tube is shown having a short protrusion that leads into a coupling face. The protrusion may be any suitable length and may be both solid or flexible. The coupling face may be a threaded a plate as shown to allow the device to be abutted or clamped to a mounting face of the workpiece to be investigated. Alternatively, the coupling face may be a screw thread that allows the device to be coupled to a port, such as a borescope port. The feed pipe may be coupled to a number of different fittings that allow the mechanism to be readily coupled with different ports on the device to be inspected and/or repaired. FIG. 5b presents a cut away of the set up in FIG. 5a. In this it can be seen how the body of the mechanism, with the passageway 52 connects to the flange 58. This in turn couples to the mount 53 and then to the feed pipe 56. The passageway is maintained throughout and allows for smooth passage of the flexible robotic arm. The connector at the end of the feed pipe, if attached to the port, results in coaxial coupling of the for the flexible robotic arm with the portal and thus provides easy entrance. Although, in this example it is presented that there is a separate mounting fixture. Instead, the mounting may be positioned on the housing or casing of the mechanism. In such a case, the flange may be directly coupled to the feed tube.

The feed mechanism may be coupled to a controller. The controller is provided to control the motion of the motors that drive the twist and feed portions of the mechanism. The controller may be coupled to a computer; this may be a PC, Laptop, tablet or phone or other suitable device having the computing power to be able run a computer program that is, as a minimum, able to interface with and provide control signals to the controller. The computing device may be used in cooperation with or may be incorporated into a controller. Such a controller may be a joystick and allow the operator to control the operation from that. The controller may also include haptic controls to provide feedback to the operator. Such a device could provide signals regarding if the flexible robotic arm has been snagged within the system or if there are frictional issues with the insertion and/or retraction of it. The computer may have a visual display connected to it to provide information on the status of the operation to an operator. Such information may include the extent to which the flexible robotic arm has been inserted into the workspace, angle of rotation of the twist mechanism. The computer may be the same as the one that operates the control of the flexible robotic arm and as all the control and information may be provided on the screen to the operator.

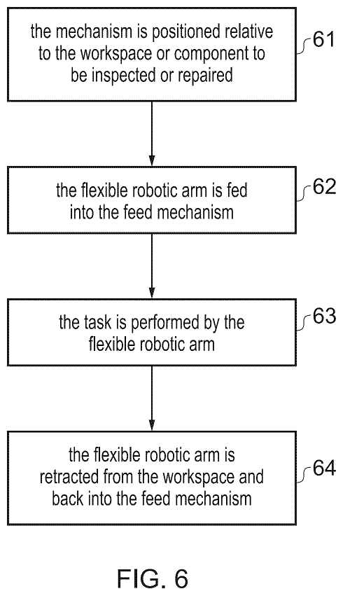

FIG. 6 presents an exemplary method of using a feed mechanism according to the present disclosure. In step 61 the mechanism is positioned relative to the workspace or component to be inspected or repaired. In some cases, such as that presented in FIGS. 5a and 5b the mechanism first has a mounting coupling attached to the mechanism. In cases in which there is a threaded access port such as a gas turbine engine the feed pipe may be screwed onto the access port and then there is a direct link between the feed mechanism and the workpiece. The positioning of the feed mechanism may be done by mounting it on a tripod or support, the workpiece or on a mount on the workpiece which is able to support a portion of the weight of the device and of the flexible robotic arm. In step 62 the flexible robotic arm is fed into the feed mechanism. Prior to this if required the spring tension can be adjusted by the movement of the screw. The flexible robotic arm may be inserted into the feed mechanism in a fixed orientation, such that when the twist portion is used there is a known position of the robot at the initial stage. Alternatively, an optical marker may be used on the flexible robotic arm which can be detected by an optical sensor within the feed mechanism. A light curtain can be used to determine the position of the flexible robotic arm within the feed mechanism. With the flexible robotic arm positioned within the feed mechanism, it can be activated to progress the flexible robotic arm into the workspace and to twist the body of the flexible robotic arm as appropriate until the head of the flexible robotic arm is positioned in the desired orientation and position. In step 63 the task is performed by the flexible robotic arm. In step 64 the flexible robotic arm is retracted from the workspace and back into the feed mechanism. In this the flexible robotic arm may be rotated to return it to its original orientation.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A feed mechanism for inserting and/or retracting a flexible robotic arm from an area, the feed mechanism comprising:
a housing, a passageway that extends about a central longitudinal axis through the length of the housing, a drive portion and a rotational portion;
the drive portion not being fixedly connected within the housing and having at least a pair of drive wheels coupled to a drive motor, the drive wheels are connected to a mounting frame with the mounting frame being connected to pivotable linkages with at least one of the linkages being connected to a spring, such that the expansion or contraction of the spring allows the drive wheels to move relative to the longitudinal axis; and
the rotational portion being coupled to a motor, the rotational motor having a gear system that connects to the drive portion and causes a rotation of the drive portion about the central longitudinal axis within the housing.

2. The feed mechanism of claim 1, wherein the spring is coupled to a threaded screw coupled to a knob, so that rotation of the screw by turning the knob causes a variation in the length of the spring.

3. The feed mechanism of claim 1, wherein the feed portion is mounted within the housing on roller bearings that extend around the feed portion.

4. The feed mechanism of claim 1, wherein the feed mechanism has an interchangeable feed core comprising a central tube that allows for the feed of the flexible robotic arm, the central tube having a plurality of cut away sections that allow to extend into the feed core, and wherein the feed core can be removed and replaced with a different feed core having a different diameter to accommodate different sized flexible robotic arms.

5. The feed mechanism of claim 1, wherein the drive motor is connected to a sub-frame within the housing, the drive motor providing rotational movement to a first drive shaft which is connected to a spur gear system, the spur gear system is connected to a second drive shaft having a worm wheel and a pair of roller bearings 33 mounted on either side of the worm wheel, and the worm wheel being coupled to a pair of worm gears that are mounted about their rotational axes and connected to drive wheel drive shafts, with each drive shaft having a pair of roller bearings mounted either side of a drive wheel.

6. The feed mechanism of claim 1, wherein the rotational portion comprises an electric motor coupled to a frame, the electric motor being connected to a spur pinion that is coupled to a spur gear, the spur gear being attached to an axle with a pair of bearing races connected either side of a worm gear, the worm gear being coupled to a worm wheel which is mounted about the outer face of the feed portion.

7. The feed mechanism of claim 4, wherein the any of the gear systems are coupled to an encoder so that the positional movement of the flexible robotic arm can be determined.

8. The feed mechanism of claim 1, wherein the drive wheels are coated with polyurethane, or natural or artificial rubber.

9. The feed mechanism of claim 1, wherein the feed mechanism is provided with a light gate to determine the position of the flexible robotic arm within the feed mechanism.

10. The feed mechanism of claim 1, wherein the feed mechanism is provided with a mount on the housing.

11. The feed mechanism of claim 1, wherein the feed mechanism is provided with a flange that can be coupled to a mounting bracket.

12. The feed mechanism of claim 1, wherein the feed mechanism is connected to a feed pipe, wherein the passageway extends continuously throughout the feed mechanism and into the feed pipe.

13. The feed mechanism of claim 1, wherein there are two pairs of drive wheels, with the pairs of drive wheels being positioned at opposite sides of the housing.

14. The feed mechanism of claim 12, wherein both sets of drive wheels are connected to springs.

15. The feed mechanism of claim 1, wherein the flexible robotic arm is one of a borescopes, endoscopes, continuum arm, snake robots hyper redundant robot.
